(19) United States
(12) Patent Application Publication
(10) Pub. No.: US 2021/0144558 A1
(43) Pub. Date: May 13, 2021

(54) ADVANCED INTERFERENCE CANCELLATION DURING SPATIAL REUSE TRANSMISSIONS IN WIRELESS SYSTEMS

(71) Applicant: QUALCOMM Incorporated, San Diego, CA (US)

(72) Inventors: Sriram Parthasarathy, Hyderabad (IN); Vinod Belur Ramachandra, Bengaluru (IN); Arul Durai Murugan Palanivelu, Bangalore (IN)

(21) Appl. No.: 16/679,671

(22) Filed: Nov. 11, 2019

(51) Int. Cl. H04W 16/10; H04W 16/14; H04L 1/00; H04L 27/26; H04W 84/12; H04B 15/00; H04L 5/00

(52) U.S. Cl. CPC H04W 16/10; H04W 16/14; H04L 1/0003; H04L 5/0032; H04W 84/12; H04B 15/00; H04L 27/2691

(57) ABSTRACT

This disclosure provides methods, systems, and devices for wireless communications. In some aspects, an access point (AP) may receive an overlapping basic service set (OBSS) packet from another AP and determine timing information associated with the OBSS packet. The AP may align data symbols of the spatial reuse packet with data symbols associated with the OBSS packet, and in some examples, transmit a spatial reuse packet to a station (STA) based on the alignment. In some examples, a STA in communication with an AP may receive a spatial reuse packet from the AP and an OBSS packet from an additional AP. The STA may determine an alignment between timing information associated with the spatial reuse packet and timing information associated with the OBSS packet, and in some examples, apply one or more signal interference mitigation schemes based on the alignment.

### TECHNICAL FIELD

This disclosure relates to wireless communications, and more specifically to advanced interference cancellation during spatial reuse transmissions in wireless systems.

### DESCRIPTION OF THE RELATED TECHNOLOGY

Wireless communications systems are widely deployed to provide various types of communication content such as voice, video, packet data, messaging, broadcast, and so on. These systems may be multiple-access systems capable of supporting communication with multiple users by sharing the available system resources (such as time, frequency, and power). A wireless network, for example a wireless local area network (WLAN), such as a Wi-Fi (i.e., Institute of Electrical and Electronics Engineers (IEEE) 802.11) network may include access points (APs) that may communicate with one or more stations (STAs) or mobile devices. The APs may be coupled to a network, such as the Internet, and may enable a mobile device to communicate via the network (or communicate with other devices coupled to the APs). A wireless device may communicate with a network device bi-directionally. For example, in a WLAN, a STA may communicate with an associated AP via downlink (DL) and uplink (UL). The DL (or forward link) may refer to the communication link from the AP to the STA, and the UL (or reverse link) may refer to the communication link from the STA to the AP.

In some wireless communications systems, as the number of APs in a given area increases, more congestion due to the APs and STAs connected thereto may lead to problems, such as decreased reliability or throughput. For example, areas having a relatively large number or a high density of APs (such as, train stations, airports, multi-dwelling apartment buildings, universities) may result in multiple areas of coverage overlap, which may result in interference due to client devices (such as, STAs) connected to the various APs. Improved techniques supportive of interference cancellation are desired.

### SUMMARY

The described techniques relate to improved methods, systems, devices, or apparatuses that support interference cancellation during spatial reuse transmissions in wireless communications systems. The improved methods and related devices disclosed herein support co-channel interference management which may enable access points (APs) and stations (STAs) to mitigate interference. In some examples, APs and STAs may mitigate interference by aligning a spatial reuse transmission with an overlapping basic service set (OBSS) interference. Additionally, the improved methods and related devices disclosed herein may enable APs and STAs to determine the alignment between the spatial reuse transmission and the OBSS interference (such as, between a transmitted spatial reuse packet and an interfering OBSS packet) with no added signaling overhead.

In some examples, an AP may receive an OBSS packet from another AP and determine timing information associated with the OBSS packet. The AP may align data symbols of the spatial reuse packet with data symbols associated with the OBSS packet, and in some examples, transmit a spatial reuse packet to a STA based on the alignment. In another example, a STA in communication with an AP may receive a spatial reuse packet from the AP and an OBSS packet from an additional AP. The STA may determine an alignment between timing information associated with the spatial reuse packet and timing information associated with the OBSS packet, and in some examples, apply one or more signal interference mitigation schemes based on the alignment.

Some aspects of the subject matter described in this disclosure can be implemented in a method at a device. The method may include receiving an OBSS set packet from a second device, determining timing information associated with a data portion of the OBSS set packet based on information in a preamble of the OBSS set packet, the data portion including one or more data symbols, determining timing information associated with a preamble of a spatial reuse packet associated with the device, aligning one or more data symbols of the spatial reuse packet with the one or more data symbols of the data portion of the OBSS set packet based on a contention-based mechanism including one or more of a delay period or a random backoff duration preceding the delay period, where a duration of the delay period is based on the timing information associated with the preamble of the spatial reuse packet, and communicating the spatial reuse packet based on the aligning.

Another aspect of the subject matter described in this disclosure can be implemented in an apparatus. The apparatus may include a processor, memory coupled with the processor, and instructions stored in the memory. The instructions may be executable by the processor to cause the apparatus to receive an OBSS set packet from a second device, determine timing information associated with a data portion of the OBSS set packet based on information in a preamble of the OBSS set packet, the data portion including one or more data symbols, determine timing information associated with a preamble of a spatial reuse packet associated with the device, align one or more data symbols of the spatial reuse packet with the one or more data symbols of the data portion of the OBSS set packet based on a contention-based mechanism including one or more of a delay period or a random backoff duration preceding the delay period, where a duration of the delay period is based on the timing information associated with the preamble of the spatial reuse packet, and communicate the spatial reuse packet based on the aligning.

Another aspect of the subject matter described in this disclosure can be implemented in an apparatus. The apparatus may include means for receiving an OBSS set packet from a second device, determining timing information associated with a data portion of the OBSS set packet based on information in a preamble of the OBSS set packet, the data portion including one or more data symbols, determining timing information associated with a preamble of a spatial reuse packet associated with the device, aligning one or more data symbols of the spatial reuse packet with the one or more data symbols of the data portion of the OBSS set packet based on a contention-based mechanism including one or more of a delay period or a random backoff duration preceding the delay period, where a duration of the delay period is based on the timing information associated with the preamble of the spatial reuse packet, and communicating the spatial reuse packet based on the aligning.

One aspect of the subject matter described in this disclosure can be implemented in a non-transitory computer-readable medium storing code at a device. The code may include instructions executable by a processor to receive an OBSS set packet from a second device, determine timing information associated with a data portion of the OBSS set packet based on information in a preamble of the OBSS set packet, the data portion including one or more data symbols, determine timing information associated with a preamble of a spatial reuse packet associated with the device, align one or more data symbols of the spatial reuse packet with the one or more data symbols of the data portion of the OBSS set packet based on a contention-based mechanism including one or more of a delay period or a random backoff duration preceding the delay period, where a duration of the delay period is based on the timing information associated with the preamble of the spatial reuse packet, and communicate the spatial reuse packet based on the aligning.

Some examples of the method, apparatuses, and non-transitory computer-readable medium described herein may further include operations, features, means, or instructions for identifying a header field associated with the overlapping basic service set packet, the header field including a high efficiency (HE) format protocol data unit (PDU) field or a non-HE format PDU field, where one or more of determining the timing information associated with the preamble of the spatial reuse packet or aligning the one or more data symbols of the spatial reuse packet with the one or more data symbols of the data portion of the overlapping basic service set packet may be based on the header field.

In some examples of the method, apparatuses, and non-transitory computer-readable medium described herein, the timing information associated with the data portion of the OBSS set packet may include one or more of a guard period associated with the data portion of the OBSS set packet, a start period associated with a beginning data symbol of the data portion of the OBSS set packet, or a duration of each data symbol of the one or more data symbols of the data portion of the OBSS set packet.

In some examples of the method, apparatuses, and non-transitory computer-readable medium described herein, determining the timing information associated with the data portion of the OBSS set packet may include operations, features, means, or instructions for decoding a field in the preamble of the OBSS set packet based on the receiving, determining a guard period associated with the one or more data symbols of the data portion of the OBSS set packet based on the decoding, determining one or more of a start period associated with a beginning data symbol of the data portion, a duration of each of the one or more data symbols of the data portion of the OBSS packet, or both, based on the decoding, and where aligning the one or more data symbols of the SR packet with the one or more data symbols of the data portion of the OBSS packet may be based on one or more of the guard period associated with the data portion of the OBSS packet, the start period associated with the beginning data symbol of the data portion of the OBSS packet, or the duration of each of the one or more data symbols of the data portion of the OBSS packet.

In some examples of the method, apparatuses, and non-transitory computer-readable medium described herein, the field in the preamble of the OBSS set packet includes one or more of a set of fields or header information.

In some examples of the method, apparatuses, and non-transitory computer-readable medium described herein, determining the timing information associated with the preamble of the spatial reuse packet may include operations, features, means, or instructions for determining that the spatial reuse packet may be in a queue of the device, identifying one or more fields in the preamble of the spatial reuse packet based on determining that the spatial reuse packet may be in the queue, and determining, based on the identifying, one or more of a start period associated with a beginning data symbol of the one or more data symbols of the spatial reuse packet or a duration of the preamble of the spatial reuse packet.

In some examples of the method, apparatuses, and non-transitory computer-readable medium described herein, the one or more fields includes one or more of a set of fields or header information.

Some examples of the method, apparatuses, and non-transitory computer-readable medium described herein may further include operations, features, means, or instructions for triggering the contention-based mechanism based on one or more of the OBSS set packet or the spatial reuse packet, the contention-based mechanism including one or more of an arbitration inter-frame spacing duration or the random backoff duration, determining a lapse of one or more of the arbitration inter-frame spacing duration or the random backoff duration, determining the duration of the delay period based on one or more of a start period associated with a beginning data symbol of the data portion of the OBSS set packet, or a duration of each of the one or more data symbols of the data portion of the OBSS set packet, or a duration of the preamble of the spatial reuse packet, or a beginning data symbol of the one or more data symbols of the spatial reuse packet, and where communicating the spatial reuse packet may be based on the duration of the delay period lapsing.

Some examples of the method, apparatuses, and non-transitory computer-readable medium described herein may further include operations, features, means, or instructions for estimating one or more symbol boundaries associated with the one or more data symbols of the data portion of the OBSS set packet based on the timing information associated with the preamble of the OBSS set packet, and where aligning the one or more data symbols of the spatial reuse packet with the one or more data symbols of the data portion of the OBSS set packet may be based on the estimating.

Some examples of the method, apparatuses, and non-transitory computer-readable medium described herein may further include operations, features, means, or instructions for estimating a channel response between the device and the second device based on one or more of the OBSS set packet or the spatial reuse packet, and where aligning the one or more data symbols of the spatial reuse packet with the one or more data symbols of the data portion of the OBSS set packet may be based on the estimating.

Some examples of the method, apparatuses, and non-transitory computer-readable medium described herein may further include operations, features, means, or instructions for estimating the channel response may be based on the information in the preamble of the OBSS set packet, the preamble including one or more of a legacy long training field symbol or one or more high efficiency signal fields.

Some examples of the method, apparatuses, and non-transitory computer-readable medium described herein may further include operations, features, means, or instructions for determining a modulation and coding scheme based on the OBSS set packet, and where aligning the one or more data symbols of the spatial reuse packet with the one or more data symbols of the data portion of the OBSS set packet may be based on the modulation and coding scheme.

Some examples of the method, apparatuses, and non-transitory computer-readable medium described herein may further include operations, features, means, or instructions for comparing one or more symbol boundaries associated with the one or more data symbols of the data portion of the OBSS set packet with one or more symbol boundaries associated with the one or more data symbols of the spatial reuse packet, and determining an alignment between at least one symbol boundary associated with the one or more data symbols of the data portion of the OBSS set packet and at least one symbol boundary associated with the one or more data symbols of the spatial reuse packet based on the aligning.

Some examples of the method, apparatuses, and non-transitory computer-readable medium described herein may further include operations, features, means, or instructions for performing an interference cancellation operation associated with the spatial reuse packet based on one or more of a channel response between the device and the second device or a modulation and coding scheme associated with the OBSS set packet, and where communicating the spatial reuse packet may be based on the interference cancellation operation.

In some examples of the method, apparatuses, and non-transitory computer-readable medium described herein, performing the interference cancellation operation may include operations, features, means, or instructions for mitigating an interference at a high efficiency long training field of the preamble of the spatial reuse packet.

In some examples of the method, apparatuses, and non-transitory computer-readable medium described herein, one or more of the device or the second device may be a station, an access point, or a non-access point station.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIGS. 1-3 show block diagrams of example wireless communications systems that support interference cancellation during spatial reuse transmissions in wireless communications systems.

FIG. 4 shows an example of a method that supports interference cancellation during spatial reuse transmissions in wireless communications systems.

FIG. 5 shows an example of a timing diagram that supports interference cancellation during spatial reuse transmissions in wireless communications systems.

FIG. 6 shows an example of a method that supports interference cancellation during spatial reuse transmissions in wireless communications systems.

FIG. 7 shows an example of a timing diagram that supports interference cancellation during spatial reuse transmissions in wireless communications systems.

FIG. 8 shows a diagram of an example system including a device that supports interference cancellation during spatial reuse transmissions in wireless communications systems.

FIGS. 9-10 show flowcharts illustrating methods that support interference cancellation during spatial reuse transmissions in wireless communications systems.

Like reference numbers and designations in the various drawings indicate like elements.

### DETAILED DESCRIPTION

The following description is directed to certain implementations for the purposes of describing the aspects of this disclosure. However, a person having ordinary skill in the art will readily recognize that the teachings herein can be applied in a multitude of different ways. The described implementations may be implemented in any device, system or network that is capable of transmitting and receiving RF signals according to any of the IEEE 16.11 standards, or any of the IEEE 802.11 standards, the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA). Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or internet of things (IOT) network, such as a system utilizing 3G, 4G or 5G, or further implementations thereof, technology.

The described techniques relate to improved methods, systems, devices, and apparatuses for interference cancellation during spatial reuse transmissions in wireless communications systems. According to aspects described herein, access points (APs) and stations (STAs) may support spatial reuse and improved interference cancellation in a wireless local area network (WLAN). For example, during a spatial reuse transmission, some APs and STAs may experience co-channel interference from sources such as different APs and STAs in an overlapping basic service set (OBSS), also referred to as co-channel interference (CCI). The APs and STAs described herein may align a spatial reuse transmission with OBSS interference (such as, align a transmitted spatial reuse packet and an interfering OBSS packet), which may mitigate the interference.

By way of example, an AP may receive an OBSS packet from another AP and determine timing information associated with the OBSS packet. The AP may align data symbols of the spatial reuse packet with data symbols associated with the OBSS packet, and in some examples, transmit a spatial reuse packet to a STA based on the alignment. In another example, a STA in communication with an AP may receive a spatial reuse packet from the AP and an OBSS packet from an additional AP. The STA may determine an alignment between timing information associated with the spatial reuse packet and timing information associated with the OBSS packet, and in some examples, apply one or more signal interference mitigation schemes based on the alignment. The described techniques may therefore include features for interference mitigation without added signaling overhead, among other benefits.

Particular aspects of the subject matter described herein may be implemented to realize one or more advantages. The described methods, systems, devices, and apparatuses provide interference cancellation techniques capable of providing improved spatial reuse transmission throughput, reducing transmission time and overhead, among other advantages. In some aspects, the proposed techniques associated with spatial reuse transmission may be provided via relatively minimal Media Access Control Hardware (MAC HW) changes, thus providing improvements in interference cancellation while minimizing added cost. Additionally, at a receiving device, the interference mitigation techniques described herein may be implemented via computer code, without hardware changes, thus providing interference mitigation without added device size.

Aspects of the disclosure are initially described in the context of a wireless communications system. Aspects of the disclosure are further illustrated by and described with reference to apparatus diagrams, system diagrams, and flowcharts that relate to interference cancellation during spatial reuse transmissions in wireless communications systems.

FIG. 1 shows a block diagram of an example wireless communications system that supports interference cancellation during spatial reuse transmissions in wireless communications systems. In the example of FIG. 1, the example system includes a WLAN 100 (also known as a Wi-Fi network). The WLAN 100 may include an AP 105 and multiple associated STAs 115, which may represent devices such as mobile stations, personal digital assistant (PDAs), other handheld devices, netbooks, notebook computers, tablet computers, laptops, display devices (such as TVs, computer monitors, etc.), printers, etc. The AP 105 and the associated STAs 115 may represent a Basic Service Set (BSS) or an Extended Service Set (ESS). The various STAs 115 in the network are able to communicate with one another through the AP 105. Also shown is a coverage area 110 of the AP 105, which may represent a Basic Service Area (BSA) of the WLAN 100. An extended network station (not shown) associated with the WLAN 100 may be connected to a wired or wireless distribution system that may allow multiple APs 105 to be connected in an ESS.

Although not shown in FIG. 1, a STA 115 may be located in the intersection of more than one coverage area 110 and may associate with more than one AP 105. A single AP 105 and an associated set of STAs 115 may be referred to as a BSS. An ESS is a set of connected BSSs. A distribution system (not shown) may be used to connect APs 105 in an ESS. In some cases, the coverage area 110 of an AP 105 may be divided into sectors (also not shown). The WLAN 100 may include APs 105 of different types (such as metropolitan area, home network, etc.), with varying and overlapping coverage areas 110. Two STAs 115 also may communicate directly via a direct wireless link 125 regardless of whether both STAs 115 are in the same coverage area 110. Examples of direct wireless links 120 may include Wi-Fi Direct connections, Wi-Fi Tunneled Direct Link Setup (TDLS) links, and other group connections. STAs 115 and APs 105 may communicate according to the WLAN radio and baseband protocol for physical and MAC layers from IEEE 802.11 and versions including, but not limited to, 802.11b, 802.11g, 802.11a, 802.11n, 802.11ac, 802.11ad, 802.11ah, 802.11ax, etc. In other implementations, peer-to-peer connections or ad hoc networks may be implemented within WLAN 100.

In some cases, a STA 115 (or an AP 105) may be detectable by a central AP 105, but not by other STAs 115 in the coverage area 110 of the central AP 105. For example, one STA 115 may be at one end of the coverage area 110 of the central AP 105 while another STA 115 may be at the other end. Thus, both STAs 115 may communicate with the AP 105, but may not receive the transmissions of the other. This may result in colliding transmissions for the two STAs 115 in a contention based environment (such as Carrier-Sense Multiple Access (CSMA)/Collision Avoidance (CA)) because the STAs 115 may not refrain from transmitting on top of each other. A STA 115 whose transmissions are not identifiable, but that is within the same coverage area 110 may be known as a hidden node. CSMA/CA may be supplemented by the exchange of a Request-to-Send (RTS) packet transmitted by a sending STA 115 (or AP 105) and a Cleared-to-Send (CTS) packet transmitted by the receiving STA 115 (or AP 105). This may alert other devices within range of the sender and receiver not to transmit for the duration of the primary transmission. Thus, RTS/CTS may help mitigate a hidden node problem.

In wireless environments such as WLAN 100, however, as the number of APs 105 increases, increased amounts of congestion due to the APs 105 and STAs 115 connected thereto may lead to problems such decreased reliability or throughput. For example, areas having a relatively large number or high density of APs 105 may result in multiple areas of coverage overlap, which may result in interference due to client devices (such as STAs 115) connected to the various APs 105. Some techniques for improving transmitted signals (such as Wi-Fi signals, for example, wireless links 120) have included improvements in coordination between the APs 105 or enhancements to Wi-Fi protocols so as to achieve Wi-Fi signals more resistant to interference.

In the 802.11ax protocol, for example, some APs 105 and STAs 115 may support spatial reuse in a WLAN (such as WLAN 100) for handling co-channel interference. During a spatial reuse transmission, however, some of the APs 105 and STAs 115 may experience co-channel interference from sources such as different APs 105 and STAs 115 in an OBSS, which may lead to a degradation of throughput. Though in some techniques, a receiver of such spatial reuse transmissions can treat the interference as thermal noise to gain some decoding improvements, improved techniques which are supportive of spatial reuse transmissions and interference cancellation are desired. The improved methods and related devices disclosed herein support co-channel interference management, for example, in WLAN radio and baseband protocols associated with spatial reuse transmissions associated with 802.11ax protocol. More specifically, the improved methods and devices may enable the APs 105 and STAs 115 to mitigate interference by aligning a spatial reuse transmission with OBSS interference. Additionally, the improved methods and related devices disclosed herein may enable the APs 105 and STAs 115 to sense the alignment of the spatial reuse transmission with the OBSS interference with no added signaling overhead.

An AP 105 may receive an OBSS packet from another AP 105 and determine timing information associated with the OBSS packet. The AP 105 may align data symbols of the spatial reuse packet with data symbols associated with the OBSS packet, and in some examples, transmit a spatial reuse packet to a STA 115 based on the alignment. A STA 115 in communication with an AP 105 may receive a spatial reuse packet from the AP 105 and an OBSS packet from an additional AP 105. The STA 115 may determine an alignment between timing information associated with the spatial reuse packet and timing information associated with the OBSS packet, and in some examples, apply one or more signal interference mitigation schemes based on the alignment.

FIG. 2 shows a block diagram of an example wireless communications system 200 that supports interference cancellation during spatial reuse transmissions in wireless communications systems. In some examples, the wireless communications system 200 may implement aspects of the wireless communications system 100. For example, the wireless communications system 200 may include an AP 105-a, an AP 105-b, a STA 115-a, and a STA 115-b, which may be examples of the corresponding devices described in FIG. 1. The AP 105-a may have a coverage area 110-a (also referred to as a BSS 110-a), and the AP 105-b may have a coverage area 110-b (also referred to as a BSS 110-b). In the example illustrated in FIG. 2, both the AP 105-a and the AP 105-b may be located in an intersection of the coverage areas 110-a and 110-b. The AP 105-a, the AP 105-b, the STA 115-a, and the STA 115-b may also be respectively referred to as ‘AP1’, ‘AP2’, ‘STA1’, and ‘STA2’. In the examples described herein, the methods and techniques may be performed by an AP 105 or a STA 115. For example, the methods and techniques may be performed by a STA, an AP, or a non-AP STA.

In the example of FIG. 2, the AP 105-a, the AP 105-b, the STA 115-a, and the STA 115-b may communicate (e.g., transmit, receive, or both) according to the 802.11ax protocol. As a feature of 802.11ax, the STA 115-a and the STA 115-b may access a channel in the presence of ongoing outside-BSS Wi-Fi transmissions (such as an OBSS), under a set of conditions. For example, aspects of IEEE 802.11ax include spatial reuse, which includes techniques for improving spectrum efficiency and network performance in dense deployments of APs. Spatial reuse utilizes, for example, BSS coloring, aspects of which include increasing a number of concurrent transmissions in an area, based on an OBSS preamble detection (OBSS PD) threshold and a received signal strength indication (RSSI) of received OBSSs.

IEEE 802.1 lax, for wireless devices (such as the AP 105-a, the AP 105-b, the STA 115-a, and the STA 115-b) transmitting on a same channel, the wireless devices may differentiate between different BSSs (such as the AP 105-a and the associated STA 115-a, or the AP 105-b and the associated STA 115-b) by using BSS colors. The BSS colors may each include a numerical identifier. BSS color information may be communicated at both a physical (PHY) layer and a medium access control (MAC) layer. For example, the BSS color information may be communicated in the preamble of an 802.11ax PHY header. In an example, each BSS (such as the AP 105-a and the associated STA 115-a) may be associated with a BSS color. In some aspects, the APs 105 (such as the AP 105-a) associated with a BSS may select and share the BSS-color with STAs 115 (such as the STA 115-a) associated with the BSS. STAs 115 (such as the STA 115-a) associated with the BSS may include the BSS color in a HE-SIG-A field of their respective PHY preambles. In an example, the AP 105-a and the STA 115-a may be associated with the same BSS, and accordingly, the same BSS color. The AP 105-a may select the BSS color and share the BSS color with the STA 115-a.

As an example of OBSS PD based spatial reuse, for a STA 115 associated with a BSS color of an OBSS, when the STA 115 detects (for example, hears) a transmission (such as, a transmission carrying an OBSS packet) coded with the same BSS color of the OBSS, the STA 115 may determine that the channel is idle based on whether the RSSI of the received OBSS packet is below an OBSS PD threshold. For example, referring to a BSS 110 (such as, the BSS 110-a associated with the AP 105-a and the STA 115-a) described above in association with FIG. 2, the STA 115-a may detect an OBSS transmission 205-b output by the AP 105-a, where the BSS-color associated with the OBSS transmission 205-b and the BSS-color associated with the STA 115-a are the same. The STA 115-a may compare the RSSI of the OBSS transmission 205-b to an OBSS PD threshold. The STA 115-a may consider that the channel is idle, for example, based on determining the RSSI of a packet (such as, an OBSS packet) included in the OBSS transmission 205-b is below the OBSS PD threshold. In some aspects, the AP 105-a may output multiple transmissions (such as, transmissions other than the OBSS transmission 205-b) in multiple directions (such as, via an omni-directional antenna).

In another example, another AP 105 (such as, the AP 105-b) may detect an OBSS transmission 205-a output by the AP 105-a and determine, based on the OBSS transmission 205-a, a spatial reuse alignment for performing a spatial reuse transmission. For example, the AP 105-b may detect the OBSS transmission 205-a and perform a spatial reuse transmission (such as spatial reuse transmission 210-a) based on the spatial reuse alignment. In some aspects, the AP 105-b may determine the spatial reuse alignment based on information included in the OBSS transmission 205-a (such as, information included in the HE-SIGA field of the OBSS packet included in the OBSS transmission 205-a).

FIG. 3 shows a block diagram of an example a wireless communications system 300 that supports interference cancellation during spatial reuse transmissions in wireless communications systems. In some examples, the wireless communications system 300 may implement aspects of wireless communications system 100. The wireless communications system 300 may include an AP 105-c, an AP 105-d, a STA 115-c, and a STA 115-d, which may be examples of the corresponding devices described in FIGS. 1 and 2. The AP 105-c, the AP 105-d, the STA 115-c, and the STA 115-d also may be respectively referred to as ‘AP1’, ‘AP2’, ‘STA1’, and ‘STA2’. In the example of FIG. 3, the wireless communications system 300 (such as, the AP 105-c, the AP 105-d, the STA 115-c, and the STA 115-d) may be supportive of spatial reuse techniques. In an example, the AP 105-c may output a transmission (such as, an OBSS transmission 305-a) to the STA 115-c. The OBSS transmission 305-a may include, for example, an OBSS packet. Another AP (such as, the AP 105-d) may detect the OBSS transmission 305-a output by the AP 105-c. In some aspects, the AP 105-d may transmit to the STA 115-d, based on the RSSI of the OBSS packet included in the OBSS transmission 305-a.

For example, during the OBSS transmission 305-a output by the AP 105-c, the AP 105-d may detect the OBSS transmission 305-a. The AP 105-d may compare an RSSI of the OBSS packet included in the OBSS transmission 305-a to an OBSS PD threshold. Based on the RSSI with respect to the OBSS PD threshold, the AP 105-d may output a transmission 310 (such as, a spatial reuse transmission) to the STA 115-d. For example, the AP 105-d may determine that the RSSI of an OBSS packet included in the OBSS transmission 305-a satisfies the OBSS PD threshold (such as, below the OBSS PD threshold). The AP 105-d may determine, based on the RSSI, that the OBSS transmission 305-a will not interfere with transmissions from the AP 105-d to the STA 115-d. For example, based on the RSSI, the AP 105-d may consider the channel to be idle.

In some aspects, the STA 115-d may be able to detect (for example, hear) transmissions which might not be intended for the STA 115-d. For example, the STA 115-d may detect (for example, hear) transmissions from the AP 105-c (such as, an OBSS transmission 305-b) which may not be intended for the AP 105-c. Co-channel interference resulting from interfering transmissions, such as the OBSS transmission 305-b, may potentially degrade benefits (such as, improved throughput) of spatial reuse. In some examples, receivers of the STAs 115 (e.g., the STA 115-c, the STA 115-d) related to spatial reuse transmissions may treat outside interference (such as, OBSS transmissions) as thermal noise to gain some decoding improvements.

In some other examples, one or more of APs 105 or STAs 115 may handle co-channel interference (e.g., in OFDM systems) by incorporating a known interference channel or modulation scheme to improve decoding performance. Here, one or more of the APs 105 or the STAs 115 may experience improved performance compared to handling outside interference as noise. The techniques described herein may provide for improved time-alignment during spatial reuse transmissions (such as, at a receiving device) of OFDM symbol boundaries of the interference and a desired data stream.

FIG. 4 shows an example of a method 400 that supports interference cancellation during spatial reuse transmissions in wireless communications systems. FIG. 5 illustrates an example timing diagram 500 that supports interference cancellation during spatial reuse transmissions in wireless communications systems. In some examples, the method 400 and timing diagram 500 may implement aspects of the wireless communications systems 100, 200 and 300. Method 400 may be implemented, for example, by an AP 105. In some examples, method 400 may be implemented by a processor of the AP 105. Example aspects of method 400 are described herein in reference to example timing diagram 500. FIG. 4 and FIG. 5 illustrate an example of spatial reuse alignment according to aspects described herein. For example, FIG. 4 and FIG. 5 describe an example of interference cancellation which includes aligning a spatial reuse transmission with OBSS interference.

At 405, an ‘AP2’ (such as, the AP 105-b illustrated in FIG. 2) may receive or detect an OBSS packet 505 included in an OBSS transmission output by an ‘AP1’ (such as, the AP 105-a as illustrated in FIG. 2). Based on the detected OBSS packet 505, for example, the ‘AP2’ may decide to perform a spatial reuse transmission. In some aspects, the ‘AP2’ may determine a format associated with the OBSS packet 505 and perform a spatial reuse transmission based the format associated with the OBSS packet 505. In some aspects, the ‘AP2’ may determine a header field associated with the OBSS packet 505. The OBSS packet 505, for example, may be an OBSS packet included in an OBSS transmission 205-a output from the AP 105-a as illustrated in FIG. 2.

In an example, the OBSS packet 505 may include a combination of preamble and data fields. In some aspects, the OBSS packet 505 may be formatted according to a high efficiency (HE) format protocol data unit (PDU) field (e.g., HE orthogonal frequency division multiple access (OFDMA) associated with 802.11ax format). In some aspects, the OBSS packet 505 may be formatted according to a non-HE PDU field (e.g., non-HE OFDMA associated with legacy formats). For example, the OBSS packet 505 may include a preamble 506 including a set of fields. In some aspects, the preamble 506 may include header information. In some aspects, the fields in the preamble 506 of the OBSS packet 505 may include a legacy short training field, a legacy long training field, a legacy signaling field, a repeat legacy signal field, or a high efficiency signaling A field. For example, the fields in the preamble 506 may include legacy preamble fields: L-STF 510 (Non-High Throughput (HT) Short Training field), L-LTF 515 (Non-HT Long Training field), and L-SIG 520 (Non-HT Signal field). In some aspects, the fields in the preamble 506 may include signal fields: RL-SIG 525 (Repeated Non-HT Signal field) and HE-SIG-A 530 (HE Signal A field), where HE may refer to fields formatted for association with 802.11ax data. The OBSS packet 505 may include a data portion 535 inclusive of one or more data symbols (such as, data OFDM symbols 535-a-535-d).

The ‘AP2’ may determine whether the OBSS packet 505 is associated with (e.g., formatted according) to a HE format PDU field (e.g., whether the OBSS packet 505 is an HE OFDM packet) or a non-HE format PDU field (e.g., whether the OBSS packet 505 is a non-HE OFDM packet). In some aspects, the ‘AP2’ may apply different decoding techniques for decoding the OBSS packet 505 based on the determination. For example, the ‘AP2’ may decode the OBSS packet 505 based on the determination. In some aspects, the ‘AP2’ may decode fields in the preamble 506 of the OBSS packet 505. In some example aspects, the ‘AP2’ may decode data portions of the OBSS packet 505.

At 410, in an example where the ‘AP2’ determines the OBSS packet 505 is formatted according to a HE format PDU field, the ‘AP2’ may decode a field in the preamble 506 of the OBSS packet 505. For example, the ‘AP2’ may decode the HE-SIG-A 530 and obtain timing information (such as, from decoding the HE-SIG-A 530) for spatial reuse alignment. For example, the ‘AP2’ may determine timing information associated with the data portion 535 of the OBSS packet 505, based on a preamble 545 of the OBSS packet 505. In some aspects, from decoding the HE-SIG-A 530, the ‘AP2’ may obtain the guard interval or guard period used for the data portion 535 of the OBSS packet 505. In some examples, from decoding the HE-SIG-A 530, the ‘AP2’ may determine a start time (such as, a start period) and duration of each of the data OFDM symbols 535-a-535-d (such as, the beginning data OFDM symbol 535-a). For example, the ‘AP2’ may determine a start time T1 and a duration D1 of the data OFDM symbol 535-a.

Alternatively, or additionally, in an example where the ‘AP2’ determines the OBSS packet 505 is formatted according to a non-HE format PDU field (e.g., whether the OBSS packet 505 is a non-HE OFDM packet), the ‘AP2’ may decode a field in the preamble 506 of the OBSS packet 505 or decode one or more (e.g., multiple) MAC PDUs (MPDUs) of the OBSS packet 505. The MPDUs may be included in the data portion 535 of the OBSS packet 505. In some examples, where the ‘AP2’ and ‘AP1’ are associated with a very high throughput (VHT) BSS, the OBSS packet 505 may include a partial association identifier (AID). In some aspects, a VHT packet including a partial AID may provide an indication to the ‘AP2’ whether the OBSS packet 505 is intended for the ‘AP2’, and the ‘AP2’ may decode the preamble 506 of the OBSS packet 505 based on the indication provided by the partial AID.

In some aspects, the data portion 535 of the OBSS packet 505 may include multiple MAC PDUs (MPDUs). In some examples, the ‘AP2’ may decode the MPDUs and determine the source and destination (e.g., read the source and destination) associated with each of the MPDUs. In some examples, the ‘AP2’ may decode one or more (e.g., multiple) of the MPDUs based on MAC headers associated with the MPDUs.

At 415, the ‘AP2’ may determine a duration D2 of a preamble 545 of a spatial reuse packet 540 in queue (such as, where the spatial reuse packet 540 is queued to be transmitted by the ‘AP2’). In some aspects, the preamble 545 may include one or more of a legacy short training field, a legacy long training field, a legacy signaling field, a repeat legacy signal field, or a high efficiency signaling A field. For example, the preamble 545 of the spatial reuse packet may include a combined duration of Legacy fields: HE-STF (HE Short Training Field), HE-LTFs (HE Long Training Fields), and HE-SIG fields (HE Signal fields).

Accordingly, in some examples, the ‘AP2’ may determine timing information (such as, the duration D2 or a start time) associated with the preamble 545 of the spatial reuse packet 540 associated with the ‘AP2’. In determining the timing information, the ‘AP2’ may determine that the spatial reuse packet 540 is in a queue of the ‘AP2’. In some aspects, the ‘AP2’ may identify one or more fields in the preamble 545 of the spatial reuse packet 540 based on determining that the spatial reuse packet 540 is in the queue. In some examples, the ‘AP2’ may determine, based on the identified fields, one or more of a start period D1 associated with a beginning data symbol (such as, data OFDM symbol 550-a) of the data symbols (such as, data OFDM symbols 550-a and 550-b) of the spatial reuse packet 540 or a duration of the preamble 545 of the spatial reuse packet 540.

Alternatively, or additionally, in the example where the ‘AP2’ determines the OBSS packet 505 is formatted according to a non-HE format PDU field, the ‘AP2’ may determine timing information of the spatial reuse packet 540 based on the non-HE format PDU field. In some aspects, the ‘AP2’ may use a non-802.11ax packet structure for transmission of a spatial reuse packet (e.g., spatial reuse packet 540), for example, based on differences in symbol duration between packets associated with 802.11ax protocols (e.g., an 802.11ax packet) packets associated with non-802.11ax protocols (e.g., a non-802.11ax OFDM packet). According to examples of aspects described herein. APs and STAs (e.g., the ‘AP2’ and the ‘STA2’) may be backward compatible with legacy OFDM packet transmission and reception.

At 420, the ‘AP2’ may trigger (start) a contention mechanism and monitor (wait) until the expiry of a Random Back-Off (RBO) timer (such as, until an RBO expiry time T2). In some aspects, the ‘AP2’ may begin the RBO timer following an Arbitration Inter-Frame Space (AIFS). In some aspects, for example, the RBO timer may indicate an RBO duration. The RBO duration may be, for example, a random amount of time (such as, in microseconds) that the ‘AP2’ may wait prior to resuming monitoring or listening for the channel to be free. For example, the RBO timer may indicate a random amount of time that the ‘AP2’ may wait for the ‘AP1’ to stop transmitting, prior to the ‘AP2’ attempting a transmission (such as, a spatial reuse transmission).

At 425, the ‘AP2’ may align one or more data symbols (such as, data OFDM symbol 550-a, data OFDM symbol 550-b) of the data portion 550 of the spatial reuse packet 540 with one or more data symbols (such as, the data OFDM symbols 535-a-535-d) of the data portion 535 of the OBSS packet 505. The ‘AP2’ may estimate one or more symbol boundaries associated with the data symbols (such as, the data OFDM symbols 535-a-535-d) of the data portion 535 of the OBSS packet 505. For example, the ‘AP2’ may estimate the symbol boundaries associated with the data symbols (such as, the data OFDM symbols 535-a-535-d) of the data portion 535 of the OBSS packet 505 based on the preamble 506 of the OBSS packet 505.

In some examples, the ‘AP2’ may align the data symbols of the data portion 535 of the OBSS packet 505 and the data symbols of the data portion 550 of the spatial reuse packet 540 based on the symbol boundaries. For example, the ‘AP2’ may compare the symbol boundaries associated with the data symbols of the data portion 535 of the OBSS packet 505 to the symbol boundaries associated with the data symbols of the data portion 550 of the spatial reuse packet 540. In some examples, the ‘AP2’ may determine an alignment between at least one symbol boundary associated with the one or more data symbols (such as, data OFDM symbols 535-a-535-d) of the data portion 535 of the OBSS packet 505 and at least one symbol boundary associated with the one or more data symbols (such as, data OFDM symbol 550-a, data OFDM symbol 550-b) of the data portion 550 of the spatial reuse packet 540, based on the comparing.

In some examples, the ‘AP2’ may determine a modulation and coding scheme based on the OBSS packet 505. In some examples, the ‘AP2’ may align the data symbols of the data portion 535 of the OBSS packet 505 and the data symbols of the data portion 550 of the spatial reuse packet 540 based on the modulation and coding scheme.

In some aspects, the ‘AP2’ may align the data symbols based on the contention-based mechanism. In some aspects, the ‘AP2’ may align the data symbols by waiting for an additional duration following a lapse of the RBO duration (such as, after the RBO expiry time T2) or the AIFS duration. For example, at the RBO expiry time T2, the ‘AP2’ may wait for an additional duration (such as, delay period r) before starting a spatial reuse transmission. In some aspects, the ‘AP2’ may wait for the additional delay T to ensure that data OFDM symbols (such as, the data OFDM symbols 550-a and 550-b) of the ‘AP2’ align with data OFDM symbols of the ‘AP1’ (such as, the data OFDM symbols 535-c and 535-d). In some aspects, the delay period r may be calculated according to Equation 1 below

T2+τ+D2=T1+k*D1,τ≥0 (1),

where k is the smallest integer value such that T2+D2≥T1+k*D1.

Accordingly, for example, the ‘AP2’ may trigger a contention-based mechanism based on one or more of the OBSS packet 505 or the spatial reuse packet 540, where the contention-based mechanism may include one or more of the RBO duration or the AIFS duration. The ‘AP2’ may determine a lapse of one or more of the AIFS duration or the RBO duration. In some aspects, the ‘AP2’ may determine the duration of the delay period τ of the contention-based mechanism, based on one or more of a start period associated with a beginning data symbol (such as, the data OFDM symbol 535-a) of the data portion 535 of the OBSS packet 505, or a duration of each of the data symbols (such as, the data OFDM symbols 535-a-535-d) of the data portion 535 of the OBSS packet 505, or a duration of the preamble 545 of the spatial reuse packet 540, or a beginning data symbol (such as, the data OFDM symbol 550-a) of the one or more data symbols (such as, the data OFDM symbols 550-a and 550-b) of the spatial reuse packet 540. In some examples, the ‘AP2’, may communicate the spatial reuse packet 540 based on the duration of the delay period T lapsing.

At 430, the ‘AP2’ may communicate a spatial reuse transmission, for example, based on the aligning at 425. In an example, the ‘AP2’ may communicate the spatial reuse transmission to a ‘STA2’. In some aspects, in communicating the spatial reuse transmission, the ‘AP2’ may communicate a spatial reuse packet 540 according to a guard interval equal to the guard interval obtained at 410. In an example, the ‘AP2’ may be the AP 105-b described in FIG. 2, the ‘STA2’ may be the STA 115-b, and the spatial reuse packet 540 may be included in the spatial reuse transmission 210-a. In some aspects, as part of communicating the spatial ruse transmission at 430, the ‘AP2’ may use 4× HE-LTF (such as, four (4) HE-LTFs) in the spatial reuse transmission (such as, in the spatial reuse packet 540). For example, the ‘AP2’ may time-align the HE-LTFs with the interference from the OBSS packet 505 to enable better channel estimation at the ‘STA2’ which may utilize cancellation techniques. According to examples of aspects of spatial reuse alignment as described herein, the ‘STA2’ may cancel interference before channel estimation, for example, based on a maintained alignment between LTF duration of the spatial reuse packet 540 and data symbol durations of the OBSS packet 505 (e.g., the duration D1 of the data OFDM symbols 535-a-535-d of the OBSS packet 505).

FIG. 6 illustrates an example of a method 600 that supports interference cancellation during spatial reuse transmissions in wireless communications systems. FIG. 7 illustrates an example timing diagram 700 that supports interference cancellation during spatial reuse transmissions in wireless communications systems. In some examples, the method 600 and timing diagram 700 may implement aspects of wireless communications system 100, 200, and 300, method 600 may be implemented, for example, by a STA 115. In some examples, method 600 may be implemented by a processor of the STA 115. Example aspects of method 600 are described herein in reference to example wireless communications system 300 and example timing diagram 700.

FIG. 6 and FIG. 7 illustrate an example of spatial reuse alignment according to aspects described herein. For example, FIG. 6 and FIG. 7 describe an example of interference cancellation, without any signaling overhead. For example, method 600 may include sensing, at a spatial reuse receiver, the alignment of a spatial reuse transmission with an interferer.

At 605, a ‘STA2’ (such as, the STA 115-d illustrated in FIG. 3) may detect an OBSS packet 701 related to (e.g., part of) an OBSS transmission output by an ‘AP1’ (such as, the AP 105-c as illustrated in FIG. 3). The OBSS packet 701 included in the OBSS transmission output by the ‘AP1’ may include a data portion inclusive of one or more data symbols (such as, data OFDM symbols 720-a-720-d). The ‘STA2’ may estimate symbol boundaries of the data symbols of the OBSS packet 701. In an example, at time T1, the ‘STA2’ may estimate boundaries of the data OFDM symbols (such as, data OFDM symbols 720-a-720-e) included in the OBSS packet 701 included in the OBSS transmission output from the ‘AP1’. The OBSS packet 701, for example, may be an OBSS packet included in an OBSS transmission 305-b output from the AP 105-c as illustrated in FIG. 3.

At 610, the ‘STA2’ may estimate the channel response (such as, interference channel estimates) between the ‘AP1’ and ‘the STA2’ based on information included in the OBSS packet 701 as output by the ‘AP1’ and a spatial reuse packet 702 as output by the ‘AP2’. For example, the OBSS packet 701 may include a preamble 715 and data fields. In some aspects, the preamble 715 may include one or more of a legacy long training field symbol or one or more high efficiency signal fields. In an example, the preamble 715 may include LTF symbols and HE-SIG fields. In some aspects, the ‘STA2’ may estimate the channel response between the ‘AP1’ and ‘the STA2’ based on the HE-SIG fields. Additionally, or alternatively, the ‘STA2’ may estimate the channel response between the ‘AP1’ and ‘the STA2’ based on LTF symbols and a modulation and coding scheme used by the ‘AP’.

At 615, the ‘STA2’ may receive a spatial reuse transmission (such as, the spatial reuse transmission 310 illustrated in FIG. 3) from the ‘AP2’. Based on relative receive power of the spatial reuse transmission from the ‘AP2’ and the OBSS transmission from the ‘AP1’, the ‘STA2’ may lock-on to the spatial reuse transmission (such as, due to a relative difference in receive power between the spatial reuse transmission and the OBSS transmission). For example, the ‘STA’ may determine that the spatial reuse transmission (such as, a spatial reuse packet 702) from the ‘AP2’ has a higher RSSI compared to the OBSS transmission (such as, the OBSS packet 701). In some examples, the difference may be due to a distance between the ‘STA2’ and the ‘AP2’ being smaller than a distance between the ‘STA2’ and the ‘AP1’). In some aspects, the spatial reuse packet may be an example of aspects of the spatial reuse packet 540 described herein.

At 620, the ‘STA2’ may determine symbol boundaries of data OFDM symbols associated with the spatial reuse transmission (such as, data OFDM symbols 710-a and 710-b included in the spatial reuse packet 702). In some examples, the spatial reuse packet 702 may include a preamble 705 (such as, the preamble 545 as described herein) inclusive of a combination of Legacy fields and HE signal fields as described herein. The ‘STA2’ may compute symbol boundaries of the data OFDM symbols 710-a and 710-b. In some aspects, the ‘STA2’ may compare the symbol boundaries of the data OFDM symbols 710-a and 710-b with the symbol boundaries of the data OFDM symbols 720-a-720-e (as obtained at 605).

At 625, the ‘STA2’ may trigger an interference cancellation at the data OFDM symbols 710-a and 710-b of the ‘AP2’. For example, the ‘STA2’ may determine that, at time T2, the symbol boundaries of the data OFDM symbols 710-a and 710-b are aligned with the symbol boundaries of the data OFDM symbols 720-d and 720-e. In some aspects, in invoking the interference cancellation techniques, the ‘STA2’ may incorporate the interference channel estimates and the modulation and scheme determined by the ‘STA2’ at 610. In some aspects, incorporating the determined interference channel estimates and the modulation and coding scheme may result in improved decoding performance. According to examples of aspects of spatial reuse alignment as described herein, the ‘STA2’ may cancel interference before channel estimation, for example, based on a maintained alignment between LTF duration of the spatial reuse packet 702 and data symbol durations of the OBSS packet 701 (e.g., the duration of data OFDM symbols 720-d and 720-c of the OBSS packet 701).

Accordingly, the ‘STA2’ may perform an interference cancellation operation associated with the spatial reuse packet 702, based on one or more of a channel response between the ‘STA2’ and the ‘AP1’ or a modulation and coding scheme associated with the OBSS packet 701 as output by the ‘AP1’. In some aspects, for cases where the ‘AP2’ has used 4× HE-LTF (such as, four (4) HE-LTFs as described with respect to 430 of FIG. 4), the ‘STA2’ may mitigate interference at the HE-LTFs (such as, at a HE-LTF) of the associated spatial reuse packet 702 before estimating the channel response from the spatial reuse transmission from the ‘AP2’.

In some aspects, the ‘STA2’ may predict behavior of the ‘AP’ and the ‘AP2’ based on conditions of the wireless communications system associated with the ‘STA2’, the ‘AP1’, and the ‘AP2’ (such as, any of the wireless communications systems 100, 200, and 300 described herein). For example, the ‘STA2’ may implement a probabilistic techniques (such as, which, in some cases, may include or refer to implementation of one or more probabilistic algorithms) capable of analyzing historical data associated with the wireless communications system and predicting the behavior of the ‘AP1’ and the ‘AP2’ based on the historical data.

In some aspects, the historical data may include past alignments between data OFDM symbols of the ‘AP1’ and the ‘AP2’. In some examples, the historical data may include traffic history and throughput associated with each of the ‘AP’ and the ‘AP2’ and devices (such as, a STA) which have connected thereto. The historical data may include, for example, a history of available time or frequency resources associated with the wireless communications system. In some examples, the historical data may include RSSI values associated with previous OBSS transmissions and spatial reuse transmissions by the ‘AP1’ and the ‘AP2’. Alternatively, or additionally, the historical data may include previous modulation and coding schemes utilized by the ‘AP1’ and the ‘AP2’.

Based on the historical data, the ‘STA2’ may predict (such as, based on time of day) whether data OFDM symbols of the ‘AP1’ and the ‘AP2’ may be aligned. Accordingly, in some aspects, the ‘STA2’ may implement the interference cancellation techniques as described herein based on the predictions, without explicitly receiving signals from the APs within the wireless communications system. In some examples, the ‘STA2’ may predict or estimate the amount of traffic each of the ‘AP1’ and the ‘AP2’ may expect to handle (such as, at a given time of day). Alternatively, or additionally, the ‘STA2’ may predict the throughput the ‘STA2’ can expect to achieve for communications with each of the ‘AP1’ and the ‘AP2’. Accordingly, the ‘STA2’ may be able to estimate channel responses for each of the ‘AP1’ and the ‘AP2’ and compare predicted data symbol boundaries associated with the ‘AP1’ and the ‘AP2’. In some examples, the probabilistic techniques may be implemented as computer executable code stored on a memory of the ‘STA2’ and executable by a processor of the ‘STA2’. Alternatively, or additionally, the probabilistic techniques described herein may be implemented by any device (such as, any STA) coupled to the wireless communications systems 100, 200, and 300 described herein.

Particular aspects of the subject matter described herein may be implemented to realize one or more advantages. The described methods, systems, devices, and apparatuses provide interference cancellation techniques capable of providing improved spatial reuse transmission throughput, reducing transmission time and overhead, among other advantages. Additionally, the proposed techniques for improved spatial reuse transmission throughput may be implemented at a transmitting device (such as, a spatial reuse transmitting device) without increasing any overhead for signaling (such as, transmitting signals to) receiving devices. In some aspects, the proposed techniques associated with spatial reuse transmission may be provided via relatively minimal Media Access Control Hardware (MAC HW) changes. At a receiving device, the interference mitigation techniques described herein may be implemented via computer code, without hardware changes.

Aspects of the techniques described herein may be implemented on Lithium powered devices (such as, battery powered, portable devices). For example, the transmission techniques (such as, spatial reuse transmission, OBSS transmission) described herein may be implemented by the MAC HW. MAC HW may compute the additional delay s that an AP (such as, the ‘AP2’) may wait so as to align with an ongoing OBSS transmission. In some examples, the MAC HW may increment the RBO counter by an amount of time (such as, microseconds) to additionally back off for alignment. In some examples, the techniques may include outsourcing delay computations to, for example, uCode with a TLV exchange sequence.

In some aspects, the receiving techniques (such as, interference mitigation) may be implemented by uCode changes, without leading to hardware (HW) changes. For example, the techniques may include combining channel estimates obtained from an OBSS packet and an InBSS (i.e., intra-BSS) packet to form a receive channel matrix of NSS_{SR}=NSS_{OBSS}+NSS_{InBSS ccc}, where N is an integer value and SS refers to a synchronization signal. In some examples, the techniques may include programming a demodulator front end (such as, demfront element) to detect the combined signal, using the InBSS component (i.e., NSS_{InBSS ccc}) of the output for detection. Such example implementations may ensure that an OBSS signal is completely rejected (assuming the channel estimates of OBSS and InBSS are orthogonal). In some aspects, the total NSS that may be detected may be based on capability of the demodulator front end. In some examples, the total NSS may be equal to the number of receiving antennas (Nrx antennas). In some aspects, additional enhancements may be achieved by upgrading hardware. In an aspect, a receiver can employ successive interference cancellation mechanisms to obtain improvements (such as, gains) above those described herein.

Total NSS_{SR} that can be handled may be increased (such as, to 2× the number of receiving antennas) by doubling the capacity of the equalizer element (such as, a demodulator front end). For example, for a 2×2 system, a full PHYA Demfront tile capable of 4SS operation may be added. Such examples may be implemented by register-transfer-level (RTL) code for handling a new combination of available HW and uCode changes.

FIG. 8 shows a diagram of an example system 800 including a device 805 that supports interference cancellation during spatial reuse transmissions in wireless communications systems. The device 805 may include components for bi-directional voice and data communications including components for transmitting and receiving communications, including a communications manager 810, an I/O controller 815, a transceiver 820, an antenna 825, memory 830, and a processor 840. These components may be in electronic communication via one or more buses (such as bus 845).

The communications manager 810 may receive an OBSS packet from a second device, communicate the spatial reuse packet based on the aligning. In some examples, the communications manager 810 may determine timing information associated with a data portion of the OBSS packet based on information in a preamble of the OBSS packet, the data portion including one or more data symbols, and determine timing information associated with a preamble of a spatial reuse packet associated with the device. In some examples, the communications manager 810 may align one or more data symbols of the spatial reuse packet with the one or more data symbols of the data portion of the OBSS packet based on a contention-based mechanism including one or more of a delay period or a random backoff duration preceding the delay period, where a duration of the delay period is based on the timing information associated with the preamble of the spatial reuse packet.

The I/O controller 815 may manage input and output signals for the device 805. The I/O controller 815 also may manage peripherals not integrated into the device 805. In some cases, the I/O controller 815 may represent a physical connection or port to an external peripheral. In some cases, the I/O controller 815 may utilize an operating system such as iOS®, ANDROID®, MS-DOS®, MS-WINDOWS®, OS/2®, UNIX®, LINUX®, or another known operating system. In other cases, the I/O controller 815 may represent or interact with a modem, a keyboard, a mouse, a touchscreen, or a similar device. In some cases, the I/O controller 815 may be implemented as part of a processor. In some cases, a user may interact with the device 805 via the I/O controller 815 or via hardware components controlled by the I/O controller 815.

The transceiver 820 may communicate bi-directionally, via one or more antennas, wired, or wireless links as described above. For example, the transceiver 820 may represent a wireless transceiver and may communicate bi-directionally with another wireless transceiver. The transceiver 820 also may include a modem to modulate the packets and provide the modulated packets to the antennas for transmission, and to demodulate packets received from the antennas. In some cases, the device 805 may include a single antenna 825. However, in some cases the device 805 may have more than one antenna 825, which may be capable of concurrently transmitting or receiving multiple wireless transmissions.

The memory 830 may include RAM and ROM. The memory 830 may store computer-readable, computer-executable code 835 including instructions that, when executed, cause the processor to perform various functions described herein. In some cases, the memory 830 may contain, among other things, a BIOS which may control basic hardware or software operation such as the interaction with peripheral components or devices.

The processor 840 may include an intelligent hardware device, (such as a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In other cases, a memory controller may be integrated into the processor 840. The processor 840 may be configured to execute computer-readable instructions stored in a memory (such as the memory 830) to cause the device 805 to perform various functions (such as functions or tasks supporting interference cancellation during spatial reuse transmissions in wireless communications systems).

The code 835 may include instructions to implement aspects of the present disclosure, including instructions to support wireless communications. The code 835 may be stored in a non-transitory computer-readable medium such as system memory or other type of memory. In some cases, the code 835 may not be directly executable by the processor 840 but may cause a computer (such as when compiled and executed) to perform functions described herein.

As detailed above, the communications manager 810 and/or one or more components of the communications manager 810 may perform and/or be a means for performing, either alone or in combination with other elements, one or more operations for supports interference cancellation during spatial reuse transmissions in wireless communications systems.

FIG. 9 shows a flowchart illustrating a method 900 that supports interference cancellation during spatial reuse transmissions in wireless communications systems. The operations of method 900 may be implemented by a device or its components as described herein. For example, the operations of method 900 may be performed by a communications manager as described with reference to FIG. 8. In some examples, a device may execute a set of instructions to control the functional elements of the device to perform the functions described below. Additionally. or alternatively, a device may perform aspects of the functions described below using special-purpose hardware.

At 905, the device may receive an OBSS packet from a second device. The operations of 905 may be performed according to the methods described herein. In some examples, aspects of the operations of 905 may be performed by a communications manager as described with reference to FIG. 8.

At 910, the device may determine timing information associated with a data portion of the OBSS packet based on information in a preamble of the OBSS packet, the data portion including one or more data symbols. The operations of 910 may be performed according to the methods described herein. In some examples, aspects of the operations of 910 may be performed by a communications manager as described with reference to FIG. 8.

At 915, the device may determine timing information associated with a preamble of a spatial reuse packet associated with the device. The operations of 915 may be performed according to the methods described herein. In some examples, aspects of the operations of 915 may be performed by a communications manager as described with reference to FIG. 8.

At 920, the device may align one or more data symbols of the spatial reuse packet with the one or more data symbols of the data portion of the OBSS packet based on a contention-based mechanism including one or more of a delay period or a random backoff duration preceding the delay period, where a duration of the delay period is based on the timing information associated with the preamble of the spatial reuse packet. The operations of 920 may be performed according to the methods described herein. In some examples, aspects of the operations of 920 may be performed by a communications manager as described with reference to FIG. 8.

At 925, the device may communicate the spatial reuse packet based on the aligning. The operations of 925 may be performed according to the methods described herein. In some examples, aspects of the operations of 925 may be performed by a communications manager as described with reference to FIG. 8.

FIG. 10 shows a flowchart illustrating a method 1000 that supports interference cancellation during spatial reuse transmissions in wireless communications systems. The operations of method 1000 may be implemented by a device or its components as described herein. For example, the operations of method 1000 may be performed by a communications manager as described with reference to FIG. 8. In some examples, a device may execute a set of instructions to control the functional elements of the device to perform the functions described below. Additionally, or alternatively, a device may perform aspects of the functions described below using special-purpose hardware.

At 1005, the device may receive an OBSS packet from a second device. The operations of 1005 may be performed according to the methods described herein. In some examples, aspects of the operations of 1005 may be performed by a communications manager as described with reference to FIG. 8.

At 1010, the device may decode a field in the preamble of the OBSS packet based on the receiving. The operations of 1010 may be performed according to the methods described herein. In some examples, aspects of the operations of 1010 may be performed by a communications manager as described with reference to FIG. 8.

At 1015, the device may determine a guard period associated with the one or more data symbols of the data portion of the OBSS packet based on the decoding. The operations of 1015 may be performed according to the methods described herein. In some examples, aspects of the operations of 1015 may be performed by a communications manager as described with reference to FIG. 8.

At 1020, the device may determine one or more of a start period associated with a beginning data symbol of the data portion or a duration of each of the one or more data symbols of the data portion of the OBSS packet based on the decoding. The operations of 1020 may be performed according to the methods described herein. In some examples, aspects of the operations of 1020 may be performed by a communications manager as described with reference to FIG. 8.

At 1025, the device may determine timing information associated with a preamble of a spatial reuse packet associated with the device. The operations of 1025 may be performed according to the methods described herein. In some examples, aspects of the operations of 1025 may be performed by a communications manager as described with reference to FIG. 8.

At 1030, the device may align one or more data symbols of the spatial reuse packet with the one or more data symbols of the data portion of the OBSS packet based on a contention-based mechanism including one or more of a delay period or a random backoff duration preceding the delay period, where a duration of the delay period is based on the timing information associated with the preamble of the spatial reuse packet. In some aspects, aligning the one or more data symbols of the SR packet with the one or more data symbols of the data portion of the OBSS packet is based on one or more of the guard period associated with the data portion of the OBSS packet, the start period associated with the beginning data symbol of the data portion of the OBSS packet, or the duration of each of the one or more data symbols of the data portion of the OBSS packet. The operations of 1030 may be performed according to the methods described herein. In some examples, aspects of the operations of 1030 may be performed by a communications manager as described with reference to FIG. 8.

At 1035, the device may communicate the spatial reuse packet based on the aligning. The operations of 1035 may be performed according to the methods described herein. In some examples, aspects of the operations of 1035 may be performed by a communications manager as described with reference to FIG. 8.

The wireless communications system or systems described herein may support synchronous or asynchronous operation. For synchronous operation, the stations may have similar frame timing, and transmissions from different stations may be approximately aligned in time. For asynchronous operation, the stations may have different frame timing, and transmissions from different stations may not be aligned in time. The techniques described herein may be used for either synchronous or asynchronous operations.

The downlink transmissions described herein also may be called forward link transmissions while the uplink transmissions also may be called reverse link transmissions. Each communication link described herein—including, for example, wireless communications system 100 and 200 of FIGS. 1 and 2—may include one or more carriers, where each carrier may be a signal made up of multiple sub-carriers (such as waveform signals of different frequencies).

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, circuits and processes described above. Whether such functionality is implemented in hardware or software depends upon the particular application and design constraints imposed on the overall system.

The hardware and data processing apparatus used to implement the various illustrative logics, logical blocks, and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more parts of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software element which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A method for wireless communications at a device, comprising:
receiving an overlapping basic service set packet from a second device;
determining timing information associated with a data portion of the overlapping basic service set packet based at least in part on information in a preamble of the overlapping basic service set packet, the data portion comprising one or more data symbols;
determining timing information associated with a preamble of a spatial reuse packet associated with the device;
aligning one or more data symbols of the spatial reuse packet with the one or more data symbols of the data portion of the overlapping basic service set packet based at least in part on a contention-based mechanism comprising one or more of a delay period or a random backoff duration preceding the delay period, wherein a duration of the delay period is based at least in part on the timing information associated with the preamble of the spatial reuse packet; and
communicating the spatial reuse packet based at least in part on the aligning.

2. The method of claim 1, further comprising:
identifying a header field associated with the overlapping basic service set packet, the header field comprising a high efficiency format protocol data unit field or a non-high efficiency format protocol data unit field,
wherein one or more of determining the timing information associated with the preamble of the spatial reuse packet or aligning the one or more data symbols of the spatial reuse packet with the one or more data symbols of the data portion of the overlapping basic service set packet are based at least in part on the header field.

3. The method of claim 1, wherein the timing information associated with the data portion of the overlapping basic service set packet comprises one or more of:
a guard period associated with the data portion of the overlapping basic service set packet;
a start period associated with a beginning data symbol of the data portion of the overlapping basic service set packet; or
a duration of each data symbol of the one or more data symbols of the data portion of the overlapping basic service set packet.

4. The method of claim 1, wherein determining the timing information associated with the data portion of the overlapping basic service set packet comprises:
decoding a field in the preamble of the overlapping basic service set packet based at least in part on the receiving;
determining a guard period associated with the one or more data symbols of the data portion of the overlapping basic service set packet based at least in part on the decoding; and
determining one or more of a start period associated with a beginning data symbol of the data portion, a duration of each of the one or more data symbols of the data portion of the overlapping basic service set packet, or both, based at least in part on the decoding,
wherein aligning the one or more data symbols of the spatial reuse packet with the one or more data symbols of the data portion of the overlapping basic service set packet is based at least in part on one or more of the guard period associated with the data portion of the overlapping basic service set packet, the start period associated with the beginning data symbol of the data portion of the overlapping basic service set packet, or the duration of each of the one or more data symbols of the data portion of the overlapping basic service set packet.

5. The method of claim 4, wherein the field in the preamble of the overlapping basic service set packet comprises one or more of a set of fields or header information.

6. The method of claim 1, wherein determining the timing information associated with the preamble of the spatial reuse packet comprises:
determining that the spatial reuse packet is in a queue of the device;
identifying one or more fields in the preamble of the spatial reuse packet based at least in part on determining that the spatial reuse packet is in the queue; and
determining, based at least in part on the identifying, one or more of a start period associated with a beginning data symbol of the one or more data symbols of the spatial reuse packet or a duration of the preamble of the spatial reuse packet.

7. The method of claim 6, wherein the one or more fields comprises one or more of a set of fields or header information.

8. The method of claim 1, further comprising:
triggering the contention-based mechanism based at least in part on one or more of the overlapping basic service set packet or the spatial reuse packet, the contention-based mechanism comprising one or more of an arbitration inter-frame spacing duration or the random backoff duration;
determining a lapse of one or more of the arbitration inter-frame spacing duration or the random backoff duration; and
determining the duration of the delay period based at least in part on one or more of a start period associated with a beginning data symbol of the data portion of the overlapping basic service set packet, or a duration of each of the one or more data symbols of the data portion of the overlapping basic service set packet, or a duration of the preamble of the spatial reuse packet, or a beginning data symbol of the one or more data symbols of the spatial reuse packet,
wherein communicating the spatial reuse packet is based at least in part on the duration of the delay period lapsing.

9. The method of claim 1, further comprising:
estimating one or more symbol boundaries associated with the one or more data symbols of the data portion of the overlapping basic service set packet based at least in part on timing information associated with the preamble of the overlapping basic service set packet,
wherein aligning the one or more data symbols of the spatial reuse packet with the one or more data symbols of the data portion of the overlapping basic service set packet is based at least in part on the estimating.

10. The method of claim 1, further comprising:
estimating a channel response between the device and the second device based at least in part on one or more of the overlapping basic service set packet or the spatial reuse packet,
wherein aligning the one or more data symbols of the spatial reuse packet with the one or more data symbols of the data portion of the overlapping basic service set packet is based at least in part on the estimating.

11. The method of claim 10, wherein estimating the channel response is based at least in part on the information in the preamble of the overlapping basic service set packet, the preamble comprising one or more of a legacy long training field symbol or one or more high efficiency signal fields.

12. The method of claim 1, further comprising:
determining a modulation and coding scheme based at least in part on the overlapping basic service set packet,
wherein aligning the one or more data symbols of the spatial reuse packet with the one or more data symbols of the data portion of the overlapping basic service set packet is based at least in part on the modulation and coding scheme.

13. The method of claim 1, further comprising:
comparing one or more symbol boundaries associated with the one or more data symbols of the data portion of the overlapping basic service set packet with one or more symbol boundaries associated with the one or more data symbols of the spatial reuse packet; and
determining an alignment between at least one symbol boundary associated with the one or more data symbols of the data portion of the overlapping basic service set packet and at least one symbol boundary associated with the one or more data symbols of the spatial reuse packet based at least in part on the comparing.

14. The method of claim 1, further comprising:
performing an interference cancellation operation associated with the spatial reuse packet based at least in part on one or more of a channel response between the device and the second device or a modulation and coding scheme associated with the overlapping basic service set packet,
wherein communicating the spatial reuse packet is based at least in part on the interference cancellation operation.

15. The method of claim 1, wherein performing the interference cancellation operation comprises:
mitigating an interference at a high efficiency long training field of the preamble of the spatial reuse packet.

16. The method of claim 1, wherein one or more of the device or the second device is a station, an access point, or a non-access point station.

17. An apparatus for wireless communications, comprising:
a processor,
memory coupled with the processor; and
instructions stored in the memory and executable by the processor to cause the apparatus to:
receive an overlapping basic service set packet from a second apparatus;
determine timing information associated with a data portion of the overlapping basic service set packet based at least in part on information in a preamble of the overlapping basic service set packet, the data portion comprising one or more data symbols;
determine timing information associated with a preamble of a spatial reuse packet associated with the apparatus;
align one or more data symbols of the spatial reuse packet with the one or more data symbols of the data portion of the overlapping basic service set packet based at least in part on a contention-based mechanism comprising one or more of a delay period or a random backoff duration preceding the delay period, wherein a duration of the delay period is based at least in part on the timing information associated with the preamble of the spatial reuse packet; and
communicate the spatial reuse packet based at least in part on the aligning.

18. The apparatus of claim 17, wherein the instructions to determine the timing information associated with the data portion of the overlapping basic service set packet are executable by the processor to cause the apparatus to:
decode a field in the preamble of the overlapping basic service set packet based at least in part on the receiving;
determine a guard period associated with the one or more data symbols of the data portion of the overlapping basic service set packet based at least in part on the decoding;
determine one or more of a start period associated with a beginning data symbol of the data portion, a duration of each of the one or more data symbols of the data portion of the overlapping basic service set packet, or both, based at least in part on the decoding; and
wherein aligning the one or more data symbols of the spatial reuse packet with the one or more data symbols of the data portion of the overlapping basic service set packet is based at least in part on one or more of the guard period associated with the data portion of the overlapping basic service set packet, the start period associated with the beginning data symbol of the data portion of the overlapping basic service set packet, or the duration of each of the one or more data symbols of the data portion of the overlapping basic service set packet.

19. The apparatus of claim 17, wherein the instructions to determine the timing information associated with the preamble of the spatial reuse packet are executable by the processor to cause the apparatus to:
determine that the spatial reuse packet is in a queue of the apparatus;
identify one or more fields in the preamble of the spatial reuse packet based at least in part on determining that the spatial reuse packet is in the queue; and
determine, based at least in part on the identifying, one or more of a start period associated with a beginning data symbol of the one or more data symbols of the spatial reuse packet or a duration of the preamble of the spatial reuse packet.

20. An apparatus for wireless communications, comprising:
means for receiving an overlapping basic service set packet from a second apparatus;
means for determining timing information associated with a data portion of the overlapping basic service set packet based at least in part on information in a preamble of the overlapping basic service set packet, the data portion comprising one or more data symbols;
means for determining timing information associated with a preamble of a spatial reuse packet associated with the apparatus;
means for aligning one or more data symbols of the spatial reuse packet with the one or more data symbols of the data portion of the overlapping basic service set packet based at least in part on a contention-based mechanism comprising one or more of a delay period or a random backoff duration preceding the delay period, wherein a duration of the delay period is based at least in part on the timing information associated with the preamble of the spatial reuse packet; and
means for communicating the spatial reuse packet based at least in part on the aligning.
